(19) United States
(12) Patent Application Publication
(10) Pub. No.: US 2007/0206636 A1
(43) Pub. Date: Sep. 6, 2007

(54) Method and system for low latency secure data communications

(75) Inventor: Michael Malcolm James Workman, Smiths Falls (CA)

Correspondence Address: CARTER, DELUCA, FARRELL & SCHMIDT, LLP, 445 BROAD HOLLOW ROAD, SUITE 225, MELVILLE, NY, 11747, US

(73) Assignee: IM Broadcasting Networks Ltd.

(21) Appl. No.: 11/366,865

(22) Filed: Mar. 2, 2006

(51) Int. Cl. H04J 3/24

(52) U.S. Cl. 370/474; 370/493

(57) ABSTRACT

A system and method for securely passing a data portion of a packet between a sending unit and a receiving unit, the method having the steps of: creating a unique table at both the sending and receiving units based on data from both; removing the white spaces of the data portion of the packet, resulting in a manipulated packet having a manipulated voice portion and header portion; forming a string using the location and number of white spaces removed and the unique table; scrambling the manipulated data portion using the string; passing the scrambled packet from the sending unit to the receiving unit; passing the string in a separate message; descrambling the scrambled packet; and adding white spaces removed in the removing step by utilizing the string and the unique table to add the correct number of white spaces in the descrambled data portion, thereby recreating the packet.

### CROSS REFERENCE TO RELATED APPLICATIONS

This application claims priority from and the benefits of Canadian Patent Application Serial No. ______ filed on Mar. 1, 2006, the entire contents of which are incorporated herein by reference.

### FIELD OF THE INVENTION

The present system and method relate to data communications over a network, and in particular to low latency secure communications over a network.

### BACKGROUND

Voice over Internet Protocol (VOIP) is a technology for sending telephone calls and other data transfer over data networks such as the Internet instead of over the traditional telephone network. It is being utilized for a number of reasons, including the ability to combine voice and data and the ability to offer some traditional telephone services, such as long distance calling, without the long distance charges typically charged by standard telephone carriers.

Traditional telephone calls establish a dedicated line between the customer and the recipient. Conversely, with Voice over IP communications, audio signals are broken into packets and sent over a data network. This makes the data packets more susceptible to interception or snooping. A serious concern for VolP communications is therefore security.

Various solutions exist to provide security for the connection to the Voice over IP server. For example, an article published by VoIP-Info.org, entitled “How to secure RSA authentication with the Asterisk IAX2 channel” teaches an authentication system using a symmetric encryption key to authenticate a user and authenticate the private branch exchange to a peer when calling out to the peer.

The problem with the above systems is that they encrypt only the header of the packet, and thus the data portion of the packet, which includes the voice call, travels unencrypted. Unencrypted voice packets present a security issue since snoopers do not necessarily care about the header, but rather are interested in putting together the unencrypted data portion of the call.

The main problem with encoding the data portion of the packet is the possibility that a server may need to decode that portion of the packet. This adds to the load of the server, which may already be heavily loaded due to the forward loop mode of operation of most VolP servers, and further the translation from one codec (coder/decoder) to another at the server.

Besides VolP communications, other forms of communications need to travel across a public network. In some cases, it would be preferable for this communication to occur in a secure manner, but without a significant overhead requirement introduced by the security provisions. One example of such communications includes streaming video.

### SUMMARY OF THE INVENTION

The present system and method overcome the deficiencies in the prior art by providing a secure method and system for communicating over a network, and in particular introduce various optimizations and solutions for providing end-to-end encryption of data. In one embodiment the present method and system are applied to a VolP call.

The present application provides for the shifting and scrambling of voice packets at a first end terminal. The data can then travel either directly between the terminals, or the devices can be serviced by one or more servers in a network. If both the sender and recipient have the ability to scramble and descramble, the data travels in an encrypted format and is received by the receiving end terminal, where it is descrambled and reassembled.

Conversely, if the receiving end terminal does not have the capability to descramble a scrambled message and communications occurs through servers in a network, the network server of the first end terminal will descramble the data prior to forwarding the data to the server of the receiving end terminal, thereby allowing the receiving end terminal to receive the data while still having some security between the first end terminal and a server.

In a VolP context, the first end terminal is a client phone handset or the client analog telephone adaptor (ATA) device. The receiving end terminal is a client phone handset or analog telephone adaptor (ATA) device

On the servers, the module made for the exchange protocol is now event driven, which generally reduces CPU usage. Combined with the scrambling technique as taught herein, this allows descrambling to occur on the server.

The present application therefore provides a method for securely passing a data portion of a packet between a sending unit and a receiving unit, the method comprising the steps of: creating a unique table at both the sending unit and receiving unit based on data from the sending unit and the receiving unit; removing, at the sending unit, the white spaces of the data portion of the packet, resulting in a manipulated packet having a manipulated voice portion and header portion; forming a string using the location and number of white spaces removed, said string being secured using said unique table; scrambling, at the sending unit, the manipulated data portion using said string, resulting in a scrambled packet having a normal header and a scrambled data portion; passing the scrambled packet from the sending unit to the receiving unit; passing the string in a separate message; descrambling, utilizing the string, the scrambled packet at the receiving unit to remove the scrambling of the scrambled data portion resulting in a descrambled data portion; and adding the white spaces removed in the removing step by utilizing the string and the unique table to add the correct number of white spaces to the correct location in the descrambled data portion, thereby recreating the packet.

The present application further provides a system for securely passing a data portion of a packet comprising: a sending unit, the sending unit having: table creation means to create a table based on a unique identifier; shifting means adapted to remove white spaces from the data portion of the packet, resulting in a manipulated packet having a data portion and a header portion and to further create a string based on the number and location of removed white spaces, said string secured using the table; scrambling means adapted to scramble the data portion of the manipulated packet using the string, resulting in a scrambled packet; and communication means adapted to pass the scrambled packet and the string; and a receiving unit, the receiving unit having: table creation means to create a table based on the unique identifier; communication means adapted to receive the scrambled packet and the string; descrambling means adapted to descramble the data portion of the scrambled packet using the string, resulting in a descrambled packet; and shifting means to add white spaces back to the data portion of the descrambled packet using the string, the string being unsecured using the table.

### BRIEF DESCRIPTION OF THE DRAWINGS

The present system and method will be better understood with reference to the drawings in which:

FIG. 1 is a schematic diagram showing the communication path between a sending client and a receiving client of the prior art;

FIG. 2 is a schematic diagram of the data path between a sending client and a receiving client in accordance with the preferred embodiment of the present system and method;

FIG. 3 is a schematic diagram of the data path between a sending client and a receiving client where the receiving client is not equipped to descramble the packet;

FIG. 4 is a simplified flow diagram showing the steps performed at the sending unit and the receiving unit for secure communications; and

FIG. 5 is a simplified data flow diagram showing messages passing between two devices.

### DETAILED DESCRIPTION OF THE DRAWINGS

The present system and method will be described in relation to Voice over Internet Protocol (VoIP), and in particular to VolP using the Asterisk protocol. This is not meant to limit the scope of the present application, and other forms of communication, including video streaming, and other protocols such as session initiation protocol (SIP) or H.323 protocol could easily be substituted for the Asterisk protocol.

Asterisk™ is one example of software that can be used to create a private branch exchange. Asterisk™ is an open source system, and uses a protocol entitled the “Inter-Asterisk Exchange (IAX) Protocol” to facilitate communication between a sending party and a receiving party. The IAX second generation (IAX2) is used herein as the base protocol for communication.

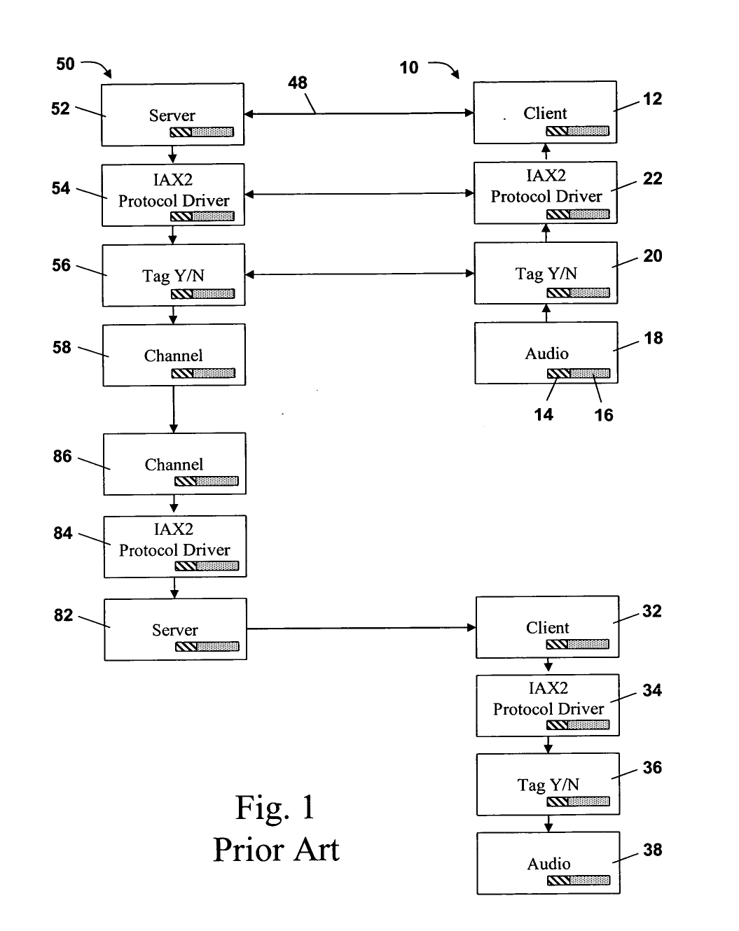

Reference is now made to FIG. 1. FIG. 1 is broken into a client side 10 and a server side 50 and further into a sending client 12 and a receiving client 32, as well as a sending server 52 and a receiving server 82.

FIG. 1 illustrates a prior art embodiment, in which header information 14 and voice data 16 originate at the audio portion 18 of a phone unit, and further proceed intact to a tag module 20. As illustrated in tag module 20, header information 14 and voice data 16 remain unchanged in this process.

Next, the header information and voice data continue through to the IAX2 protocol driver 22, again with no manipulation of the voice data or the header information. The header information and voice data further continue to a client portion of the phone unit, depicted in FIG. 1 using sending client 12.

Sending client 12 sends the header and voice data over communications channel 48 to sending server 52. As will be appreciated by those skilled in the art, channel 48 could include various means for sending the header information invoice data 16 to sending server 52. Such options include the Internet, or connection from the client device to a data network.

As is further seen in FIG. 1, sending server 52 further includes an IAX2 protocol driver 54 and this is synchronized with the client IAX2 protocol driver 22. Further, sending server 52 includes a tag module 56 which is synchronized with tag module 20 of sending client 12. Server 52 also includes a channel 58 which is used to send header information 14 and voice data 16 to server 82.

Server 82 includes an IAX2 protocol driver in a preferred embodiment. However, in other embodiments server 82 does not need to use the Asterisk™ system and could include other protocol drivers 84, for example SIP or H.323.

Server 82 further includes a channel 86 that communicates through channel 58 to server 52, thereby receiving header information 14 and voice data 16. As will be appreciated by those skilled in the art, header information 14 and voice data 16 have been unchanged up to server 82.

Once server 82 has header information 14 and voice data 16, it forwards this information to receiving client 32. Receiving client 32 includes an IAX2 protocol driver 34 that synchronizes with IAX2 Protocol Drive 84. Further, a tag module of 36 is used to synchronize with a similar tag module on server 82 (not shown).

Finally, the audio portion 38 of the receiving client puts packets together and transmits the audio if the packets are part of a voice call.

As will be appreciated by those skilled in the art, a current network likely will not include tag modules 20, 56 and 36, and without this module, other components that expect the tag module 20, 56 or 36 will assume that they are set to “No” to indicate that the data is not being manipulated.

As will be appreciated by those skilled in the art, channel 58 determines the protocol provider and internal extensions, along with the destination information, and forwards this to the destination channel 86. The channel also stores the header information.

Thus, in an existing process, there is no “tagging” to indicate that some manipulation of the voice data has taken place. The header information and voice data pass this tagging operation and enter the IAX2 Protocol driver where the header information is confirmed and the IAX2 version is checked. This process is part of the sending client device, and the sending client device therefore transmits the header and voice data untouched to the sending server. The sending server does not manipulate the voice data and the voice data is sent, as is, to the receiving server 82.

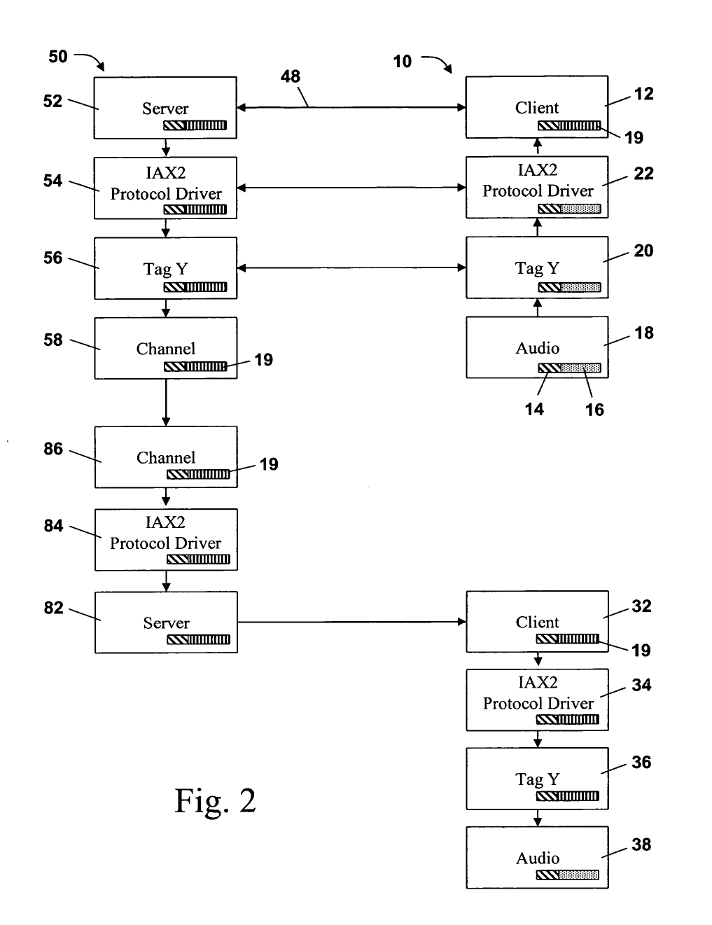

Reference is now made to FIG. 2. Like numerals will be used for components that are the same between FIGS. 1 and FIG. 2.

As in FIG. 1, a sending client 12 includes an audio portion 18. Header information 14 and voice data 16 are generated in audio portion 18. The header information 14 and voice data 16 are then passed through tag module 20, which has now been set to “Y” (yes) to indicate that the voice data is being manipulated.

Further, the header information 14 and voice data 16 are passed through a IAX2 protocol driver 22 to sending client 12.

At sending client 12, a preferred embodiment includes an operating system that is pre-configured on to sending client 12 that allows voice data manipulation. Data client 12 performs manipulation in two stages.

The first stage of manipulation is the left justification of the hexadecimal information in the voice data. In other words, all of the zeros in the voice data 16 are removed. For example:

Hexadecimal data prior to “left justification” could be: 00 00 34 25

Hexadecimal data after “left justification” could be: 34 25.

As will be understood by those skilled in the art, various numbers of leading zeros could exist for the voice data portion 16. Specifically, there could be no leading zeros or there could be up to seven leading zeros for the data and thus the left shift is not configured to a specific number. Further, since the data length is variable, no additional data (such as redundant zero) need to be added after the shifted data.

In the case of a data packet any portion in which a zero occurs (a “white space”) could be stripped and the location of the stripped portion kept track of for recreation of the packet, as explained in more detail below.

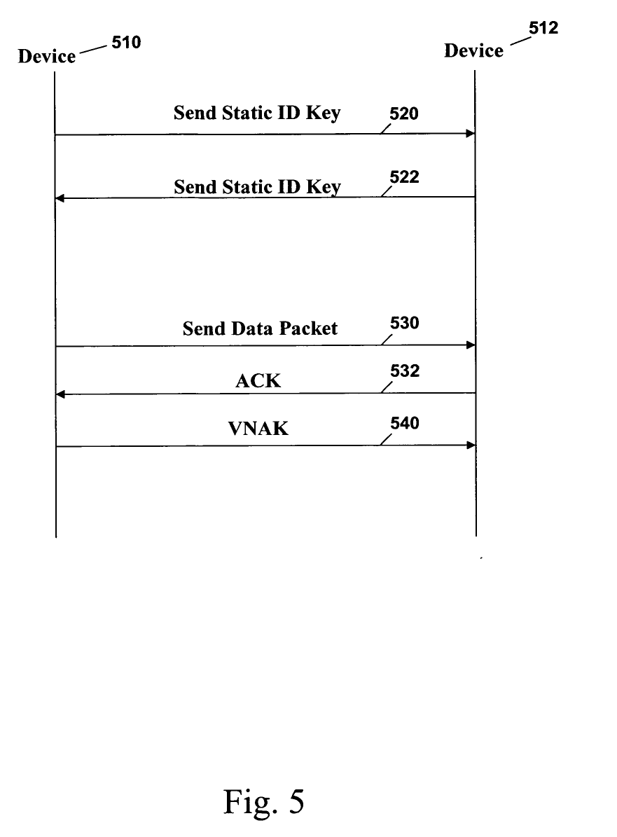

Referring to FIG. 5, FIG. 5 illustrates a simplified signalling diagram between a sending device 510 and a receiving device 512. As will be appreciated by those skilled in the art, the sending device 510 could be client 12 from FIG. 1, 2 or 3 and the receiving device could be server 52 from FIG. 1, 2 or 3 or could be client 32 from FIG. 1, 2 or 3.

When communication is desired between device 510 and device 512, a static ID key is created by device 510 and passed in message 520 to device 512. The static ID key for device 510 is comprised of the CPU serial ID of device 510, if available, or alternatively the media access control (MAC) address, combined with a real time and date. This unique number is then passed in message 520 to device 512.

Device 512 similarly creates its own static ID key based on its CPU serial ID or MAC address combined with a real time and date and sends this back to device 510 in message 522.

In this way, each of device 510 and 512 have two static ID keys, their own and the key for the device that they wish to communicate with.

Each of the static ID keys is used to create a table associating a hexadecimal (HEX) value with a shift value. The two static ID keys therefore create two tables, which are then mixed to create a base set table that allows only communication between the devices 510 and 512.

If a call is transferred to a new device during the call, a new key is sent to the other device and a new table is created.

When device 510 wishes to send a data packet securely to device 512, it needs to add the security features of the present method to the data packet. This is done by utilizing the base set table described above along with the raw data to be sent. The data packet is checked by sending device 510 for any zeros (white spaces). The locations and number of zeros is noted and the zeros are stripped out, as described above.

Further, a HEX string is created from the base key table. Specifically, the base key table may indicate that a shift of four spaces should be designated with a marker designated by the HEX character “A” and thus an A is appended in the proper position in the HEX string. Similarly, the remainder of the data is shifted and the HEX string is updated for each shift by adding a marker and place value for each shift.

Since no additional digits are appended to the data packet to replace leading zeros that were removed, a packed data packet is created.

For additional security, the packed data packet is then scrambled using the hex string as a scramble code.

The scrambled, packed data packet is then sent in message 530 to device 512.

Device 512 acknowledges the data packet in message 532, whereupon device 510 sends a variable network acknowledgement (VNAK) 540 to device 512.

A VNAK 540 is an acknowledgement that is created between two devices or from a device to a server. The main reason for the variable network acknowledgement is to alert devices of pending data that are to be sent or received and also to verify the validity of data origins. The IAX protocol uses UDP ports to access networks through firewalls. Since UDP ports do not remain open by nature, VNAK enables data to be sent by initiating new data calls and transmissions.

The VNAK of a IAX2 protocol is modified for the present system and method by adding the following header structure:

TABLE 1
Header Structure

| | | | | | |
|---|---|---|---|---|---|
| Short | Type | 1 byte | 1 byte | | |
| Short | Flag | 1 byte | 1 byte | | |
| Int. | Datalen | 1 byte | 1 byte | 1 byte | 1 byte |
| Char | Data [0] | 1 byte | | | |

For the above, Type is a two byte field that is variable according to the type of transmission. This could be voice, video or data. The flag is a two byte field and is variable according to the function. It can be encoding, decoding, audio format, data format or challenge to reconvert data. Details concerning the header types and flags are listed below, along with shift value (1<1 means 256, 1<2 means 255ˆ2+1, etc):

| Field Types | |
|---|---|
| NETX_RAW_DATA = | (1 < 1) |
| NETX_VIDEO_DATA = | (1 < 2) |
| NETX_AUDIO_DATA = | (1 < 3) |
| Field Flags | |
| NETX_SHIFT_UPPER = | (1 < 1) |
| NETX_SHIFT_LOWER = | (1 < 2) |
| NETX_SHIFT_MIXED = | (1 < 3) |
| NETX_SHIFT_ORDER = | (1 < 4) |
| NETX_SHIFT_NONE = | (1 < 5) |

The above provides for shift values that are run through the base key table to create a hex code.

Datalen is a four byte field that is variable according to the codec type. For example, it can be 220 bytes in ulaw. In g723 it can be 160 bytes and in g729 it can be 130 bytes. These codecs are identified for illustrative purposes only and are not meant to be limiting.

Char is a one byte field and is variable depending on the data length information.

The VNAK message 540 includes the above header structure. Further, the HEX string created when packing the data to be sent in message 530 is inserted into the char field, the length of the HEX string is inserted into the datalen field, the type and flag fields are identified to allow the receiving device 512 to identify the pattern used in the base table in order to realign the data to its proper order.

The above therefore provides for the compression of a data packet to remove blank spaces and further scrambling with a HEX key that is unique for the communication between device 510 and 512.

Referring again to FIG. 2, the above manipulation produces scrambled voice data 19, which is passed from sending client 12 to sending server 52. As illustrated in FIG. 2, scrambled voice data 19 is depicted using horizontal lines rather than a dotted area as in voice data 16.

Server 52 passes scrambled voice data 19 through the IAX2 protocol driver and the tag modules 54 and 56 respectively. As with FIG. 1 above, the IAX2 protocol driver 54 is synchronized with the IAX2 protocol driver 22 of sending client 12, and further tag module 56 is synchronized with tag module 20.

Sending server 52 next uses channel 58. As with FIG. 1, the channel determines the protocol provider and internal extensions, along with the destination information, and forwards it to the destination channel 86. Server 82 interacts with destination channel 86 and has an IAX2 protocol driver 84 that is synchronized with protocol driver 34 on receiving client 32. Receiving client 32 further has a tag module 36, which verifies that the tag on the receiving client 32 is YES, indicating that receiving client 32 can handle data manipulation. Client 32 then descrambles voice data 19, right shifts the information the correct number of digits and recomposes voice data 16. This is based on the HEX key received in a separate VNAK message.

The voice data 16 is then passed to audio module 38 where it is recomposed and presented to the user.

According to the above, the voice data is therefore scrambled at the sending client 12 and descrambled at the receiving client 32. The sending server 52 and receiving server 82 are programmed to support the manipulation of voice data, therefore passing the voice data in its scrambled format and allowing the data to be recomposed at the receiving client 32.

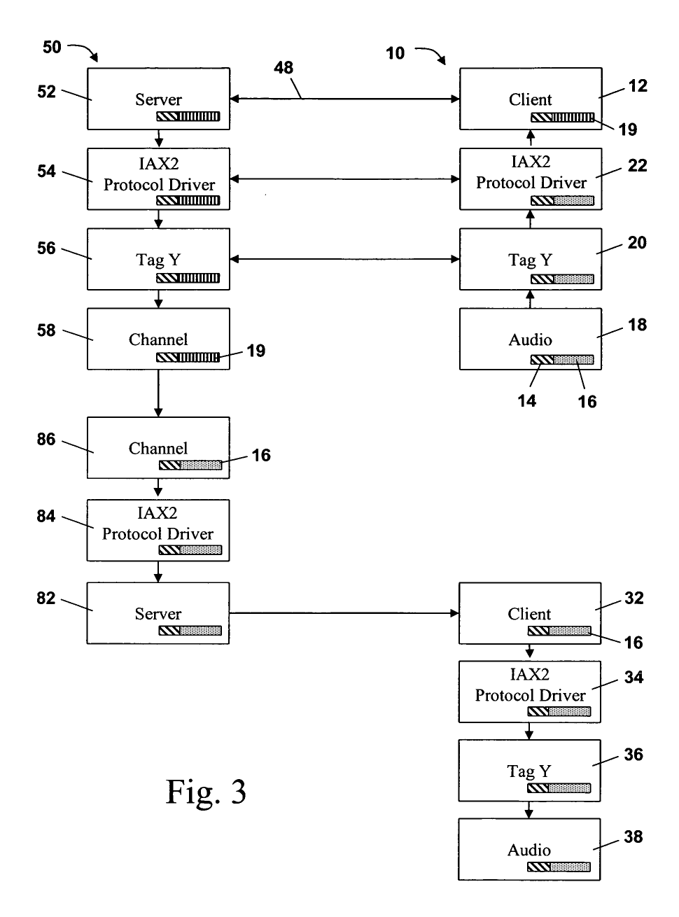

As will be appreciated by those skilled in the art, signalling messages are continually being passed between client 12 and client 32. This message could include information about whether client 32 can descramble the voice data 19, and if not, server 52 is used for this purpose, as explained in more detail below with regard to FIG. 3.

Reference is now made to FIG. 3. FIG. 3 shows an alternative embodiment of the system of FIG. 2 in which the destination unit does not support scrambled data. In this case, descrambling of the data occurs at the last point in the communication path where encryption is supported. Specifically, if receiving client 32 does not support the descrambling of data, receiving server 86 will also not support the descrambling of data. Thus, the last point of scrambling support is server 52.

As illustrated in FIG. 3, server 52 receives scrambled voice data 19 and passes it through protocol driver and tag modules 54 and 56 respectively.

The data is next passed to channel 58 which, when communicating with channel 86, realizes that data scrambling is not supported by client 32. Server 52 then must descramble the signal in order to allow communications between sending client 12 and receiving client 32. This descrambling occurs at the server 52 and provides for the descrambling and right shifting of the voice data bytes to recompose a descrambled voice data portion 16.

Descrambled voice data portion 16 is passed through channel 86 to server 82. The descrambled voice data 16 is then passed to client 32 and ultimately to audio portion 38.

Server 52, in order to be able to accommodate the descrambling of a voice data portion 19, has been modified to become an event driven system. This prevents extra CPU usage for large call volumes and only runs when data is going in or out of the client phone or ATA.

Similarly, although not illustrated, data coming from client 32 back to client 12 is not scrambled until it reaches server 52. When it reaches server 52, server 52 scrambles the data through the reverse of the above. Specifically, the voice data 16 is left shifted to remove the leading zeros and is then scrambled. As with the above, since server 52 is event driven in this case and the scrambling process not CPU intensive, the excess CPU requirement to scramble and shift the data is minimal and allows the CPU power to be maintained for a normal codec and sending operations.

As will be appreciated by those skilled in the art, the conversion from the system of FIG. 2, in which the security is maintained between two devices, and the system of FIG. 3, in which the security is only maintained to the server, can be dynamic. Specifically, if a call is transferred, during the call, to a device that does not support data manipulation, the server could take over the descrambling and scrambling operations. This is accomplished by having signalling messages going between devices and the device and server indicating whether the devices support audio (or video) manipulation. Once a new device is connected, it will need to provide its static ID key and information regarding whether it supports data manipulation, and if not the server must be able to take over these functions.

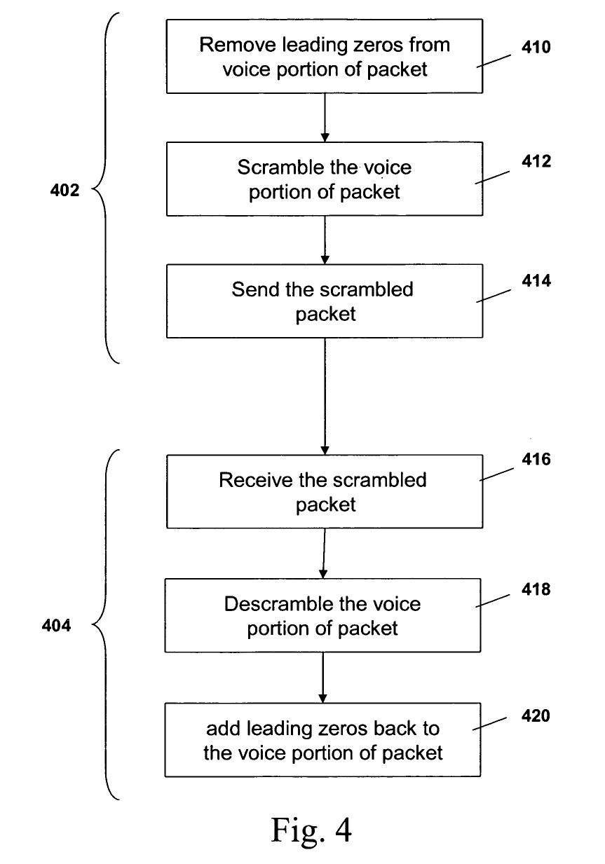

Referring to FIG. 4, FIG. 4 shows a flow chart of the communications between a sending unit 402 and a receiving unit 404. As would be appreciated by those skilled in the art, the sending unit could be either the sending client 12 or sending server 52 from FIG. 2 or 3. Further the receiving unit could be either the sending server or the receiving client. This is because the receiving unit descrambles and reassembles the message, and is therefore the last point that encryption exists in the communication chain. In the preferred embodiment this will not be the receiving server 82 of FIG. 2 or 3.

In FIG. 4, the sending unit, in step 410 the white spaces are removed from the voice portion of the packet, as described above. The sending unit 410 next proceeds to step 412 in which the voice portion of the manipulated packet is next scrambled.

The sending unit 402, in step 414 next sends the scrambled packet to the receiving unit 404.

Receiving unit 404 receives the scrambled packet at step 416. The receiving unit next proceeds to step 418 in which it descrambles the voice portion of the packet. As will be appreciated by those skilled in the art, this is accomplished by applying the reverse algorithm to that applied in step 414 above.

Once the descrambled voice portion of the packet is created, the receiving unit, in step 420 adds back the leading zeros to the voice portion of the packet, thereby recreating the packet as it existed prior to step 410.

As will be appreciated, if the sending unit 402 is a client unit such as a phone or ATA, it will already be synchronized with an associated server to have the correct IAX2 protocol drivers and to ensure that the tag module (as seen in FIGS. 2 and 3) in the sending unit is the same as the tag module in the associated server.

The above therefore provides for the passing of scrambled data from a sending client to a receiving client in which at least a portion of the data path is scrambled to protect the voice data. In a preferred embodiment, both the sending client and receiving client have the capability to scramble and descramble the voice data portion of the message, in which case the receiving server and sending server merely pass the data through to the sending client and receiving client. If, however, one of the sending client or receiving client do not support encryption or not encryption scrambling, the server 52 or server 82 perform a scrambling and descrambling step respectively. In order to accommodate this and allow the CPU usage to not be too adversely effected, server 52 and server 82 have been modified to be event driven rather than utilizing a normal forward loop according to the prior art. Further, because of the scrambling algorithm with the left shift and the manipulation of the hexadecimal bytes, the descrambling process and the scrambling process are not CPU intensive and therefore take normal CPU usage.

Due to the two stage manipulation with tables built for communication between two specific devices/servers, the voice data will be virtually impossible to tap into and a level of confidentiality not currently known will be achieved.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

We claim:

1. A method for securely passing a data portion of a packet between a sending unit and a receiving unit, the method comprising the steps of:
creating a unique table at both the sending unit and receiving unit based on data from the sending unit and the receiving unit;
removing, at the sending unit, the white spaces of the data portion of the packet, resulting in a manipulated packet having a manipulated voice portion and header portion;
forming a string using the location and number of white spaces removed, said string being secured using said unique table;
scrambling, at the sending unit, the manipulated data portion using said string, resulting in a scrambled packet having a normal header and a scrambled data portion;
passing the scrambled packet from the sending unit to the receiving unit;
passing the string in a separate message;
descrambling, utilizing the string, the scrambled packet at the receiving unit to remove the scrambling of the scrambled data portion resulting in a descrambled data portion; and
adding the white spaces removed in the removing step by utilizing the string and the unique table to add the correct number of white spaces to the correct location in the descrambled data portion, thereby recreating the packet.

2. The method of claim 1, wherein one of the sending unit and the receiving unit is a server.

3. The method of claim 2, wherein the server is event driven.

4. The method of claim 1, wherein the sending unit is a phone unit or an analog telephone adapter.

5. The method of claim 4, further comprising the step of synchronizing the sending unit with an associated server to indicate that voice data will be manipulated, set synchronizing step occurring before said scrambling step.

6. The method of claim 1, wherein the unique table is created based on a key formed from one of the CPU serial identifier and the media access control (MAC) address the sending unit, along with time and date information, combined with a key formed from one of the CPU serial identifier and the media access control (MAC) address the receiving unit, along with time and date information.

7. The method of claim 1, wherein the separate message is a variable network acknowledgement message.

8. The method of claim 1, wherein the sending unit and receiving unit operate for a voice over internet protocol system.

9. The method of claim 8, wherein the voice over internet protocol is selected from the group consisting of AsteriskTM, Session Initiation Protocol and H.323 protocol.

10. The method of claim 1, wherein the sending unit and receiving unit operate to send streaming video.

11. A system for securely passing a data portion of a packet comprising:
a sending unit, the sending unit having:
table creation means to create a table based on a unique identifier;
shifting means adapted to remove white spaces from the data portion of the packet, resulting in a manipulated packet having a data portion and a header portion and to further create a string based on the number and location of removed white spaces, said string secured using the table;
scrambling means adapted to scramble the data portion of the manipulated packet using the string, resulting in a scrambled packet; and
communication means adapted to pass the scrambled packet and the string; and
a receiving unit, the receiving unit having:
table creation means to create a table based on the unique identifier;
communication means adapted to receive the scrambled packet and the string;
descrambling means adapted to descramble the data portion of the scrambled packet using the string, resulting in a descrambled packet; and
shifting means to add white spaces back to the data portion of the descrambled packet using the string, the string being unsecured using the table.

12. The system of claim 11, wherein one of the sending unit and the receiving unit is a server.

13. The system of claim 12, wherein the server is event driven.

14. The system of claim 11, wherein the sending unit is a phone unit or an analog telephone adapter.

15. The system of claim 14, wherein the phone unit or analog telephone adapter include an audio portion to create the packet.

16. The system of claim 15, wherein the phone unit or analog telephone adapter include a protocol driver adapted to synchronize with a server protocol driver of an associated server.

17. The system of claim 16, wherein the phone unit or analog telephone adapter further include a tag module adapted to synchronize with a server tag module of an associated server

18. The system of claim 11, wherein the sending unit and receiving unit operate for a voice over internet protocol system.

19. The method of claim 18, wherein the voice over internet protocol is selected from the group consisting of AsteriskTM, Session Initiation Protocol and H.323 protocol.

20. The method of claim 11, wherein the sending unit and receiving unit operate to send streaming video.
